(19) United States
(12) Patent Application Publication
(10) Pub. No.: US 2026/0022072 A1
(43) Pub. Date: Jan. 22, 2026

(54) CORE WALL-THINNING DESIGN METHOD FOR PRESTRESSED HIGH-PERFORMANCE CONCRETE CYLINDER PIPE

(71) Applicant: ZHENGZHOU UNIVERSITY, Zhengzhou (CN)

(72) Inventors: Shaowei HU, Zhengzhou (CN); Guoan LIU, Zhengzhou (CN); Yuquan HU, Zhengzhou (CN); Yuxiao YE, Zhengzhou (CN); Xiangqian FAN, Zhengzhou (CN); Changxi SHAN, Zhengzhou (CN)

(73) Assignee: ZHENGZHOU UNIVERSITY, Zhengzhou (CN)

(21) Appl. No.: 19/182,676

(22) Filed: Apr. 18, 2025

(30) Foreign Application Priority Data
Jul. 22, 2024 (CN) 202410978842.8

(51) Int. Cl. C04B 28/04; B28B 21/60; C04B 14/06; C04B 14/48; C04B 16/06; C04B 18/08; C04B 24/26; C04B 40/00; C04B 40/02; C04B 103/00; C04B 103/32; C04B 111/56

(52) U.S. Cl. CPC C04B 28/04; B28B 21/60; C04B 14/068; C04B 14/48; C04B 16/0633; C04B 18/08; C04B 24/267; C04B 40/0067; C04B 40/024; C04B 2103/0051; C04B 2103/32; C04B 2111/56

(57) ABSTRACT

A core wall-thinning design method for a prestressed high-performance concrete cylinder pipe is provided. The PCCP uses high-performance concrete, which includes P.O 42.5 or P.O 52.5 portland cement, river sand, mineral powder, fly ash, silica fume, steel fibers, polypropylene fibers, a high-efficiency polycarboxylate superplasticizer, and superabsorbent resin, and which is prepared by: adding all cementitious materials, sand and superabsorbent resin for mixing until uniform dispersion; dissolving the superplasticizer in water, and adding the superplasticizer dissolved in water and evenly stirring; and evenly adding steel fibers and polypropylene fibers and evenly stirring. The compressive strength and the tensile strength of the high-performance concrete are increased. A core wall-thinning design method, includes: establishing an axisymmetric double-layer ring plane strain model, to analyze radial displacement and circumferential stress of an outer ring and an inner ring of the PCCP, and then deriving a calculation formula of the wall-thinning design.

### CROSS REFERENCE TO THE RELATED APPLICATIONS

This application is based upon and claims priority to Chinese Patent Application No. 202410978842.8, filed on Jul. 22, 2024, the entire contents of which are incorporated herein by reference.

### TECHNICAL FIELD

The present invention relates to the innovative technical field of a pipe structure, in particular to a core wall-thinning design method for a high-performance prestressed concrete cylinder pipe.

### BACKGROUND

A prestressed concrete cylinder pipe (PCCP), characterized by advantages such as high pressure resistance, good impermeability, smooth inner surface with low resistance, ease of installation, and low maintenance costs, has become a first choice of pipes for large-diameter, high-pressure and long-distance water diversion projects at home and abroad, and is extensively applied in major water diversion and transfer projects such as the South-to-North Water Diversion Project, the Chuoer-Xiliao Water Conservancy Project, and the Beibu Gulf Water Resources Allocation Project in Guangdong.

A conventional PCCP core is usually made of ordinary concrete, but the ordinary concrete has shortcomings in terms of strength, durability, and crack resistance. Therefore, cylinder rust and steel wire breakage are easily caused. In addition, as a pipe diameter increases, a thickness of the core significantly increases, resulting in an increase in a weight of the pipe, and posing challenge to hoisting, transportation, and installation of the pipe. As a novel high-performance material, high-performance concrete has excellent mechanical properties and durability. In addition, according to wall-thinning design, the weight of the pipe and material costs can be reduced, and overall performance of the pipe can be improved.

### SUMMARY

In view of problems of the heavy weight and the poor compressive performance of the existing PCCP, a reliable core wall-thinning design method for improving overall mechanical properties of the PCCP and achieving lightweight design is provided in the present invention.

To achieve the foregoing objective, the technical solution according to the present invention is that the present invention provides a core wall-thinning design method for a prestressed high-performance concrete cylinder pipe, including: replacing core concrete of the PCCP with high-performance concrete, and using the wall-thinning design method to achieve wall-thinning of the PCCP. The core wall-thinning design method includes: establishing an axisymmetric double-layer ring plane strain model, to analyze radial displacement and circumferential stress of an outer ring and an inner ring of the PCCP, and then deriving a calculation formula of the wall-thinning design of the PCCP.

Preferably, the high-performance concrete includes P.O 42.5 or P.O 52.5 portland cement, river sand, mineral powder, fly ash, silica fume, steel fibers, polypropylene fibers, a high-efficiency polycarboxylate superplasticizer, and superabsorbent resin.

Preferably, a method for mixing the high-performance concrete includes: first, adding all cementitious materials, sand and superabsorbent resin for dry mixing until uniform dispersion; then, dissolving the superplasticizer in water, and adding the superplasticizer dissolved in the water to mixture and evenly stirring the mixture; and finally, evenly adding steel fibers and polypropylene fibers to the mixture and evenly stirring the mixture.

Preferably, after the high-performance concrete is made, a core mold needs to be first cleaned up, a separator is evenly sprayed, a position of the core mold is fixed, and the cylinder is put into the mold; then the high-performance concrete is cast, a cast surface of inner concrete is higher than a cast surface of outer concrete, and a vibrator is turned on when feeding, until the concrete surface is free of bubbles and then stops vibrating; subsequently, after the core is formed, steam curing is performed, and a heating rate is not allowed to be greater than 25/h; and finally, a cubic test block is reserved in a same batch during casting, and when compressive strength of the cubic test block is not less than 36 MPa, the pipe can be demolded and the core concrete is formed.

According to a first solution of the present invention, a core wall-thinning design method is provided, including: establishing an axisymmetric double-layer ring plane strain model, to analyze radial displacement and circumferential stress of an outer ring and an inner ring of the PCCP, and deriving a calculation formula of the wall-thinning design of the PCCP.

The establishing an axisymmetric double-layer ring plane strain model includes: simplifying the pipe to the axisymmetric double-layer ring plane strain model, including converting the inner ring being defined as core concrete plus a thickness into cylinder concrete, and converting the outer ring being defined as a protective layer into core concrete according to cylinder stiffness contribution, where the conversion method is:

$${t}_{y}^{′} = \frac{{E}_{y}}{{E}_{c}} {t}_{y} \qquad ( 1 )$$

$$t = {t}_{y}^{′} + {t}_{c} \qquad ( 2 )$$

$$t = {r}_{p} + {r}_{1} \qquad ( 3 )$$

where t_{y} is a thickness of the cylinder, E_{y} and E_{c} are elastic modulus of the cylinder and the concrete, t′_{y} is a thickness of the cylinder converted into concrete, t_{c} and t are the concrete core and an effective thickness after conversion, r₁ is an inner diameter of the inner ring, and rₚ is an outer diameter of the inner ring.

The radial displacement of inner water pressure, preload pressure, and contact stress of the outer ring on the inner ring is expressed as:

$${μ}_{1 p} = \frac{( 1 + {μ}_{c} )}{{E}_{c}} \frac{{r}_{1}^{2} {r}_{p}^{2} ( {q}_{1} - {q}_{2} - {q}_{c} )}{( {r}_{p}^{2} - {r}_{1}^{2} ) r} + \frac{( 1 - {μ}_{c} )}{{E}_{c}} \frac{{q}_{1} {r}_{1}^{2} - ( {q}_{2} + {q}_{c} ) {r}_{p}^{2}}{{r}_{p}^{2} - {r}_{1}^{2}} r \qquad ( 4 )$$

where q₁ is the internal water pressure, q₂ is the preload pressure, q_{c} is the interlayer contact stress in the rings, μ_{c} is a Poisson's ratio of the high-performance concrete, E_{c} is the elastic modulus of the high-performance concrete, and μ₁ₚ is the radial displacement of the inner ring under load.

The outer ring is only subjected to the interlayer contact stress of the inner ring on the outer ring, and the radial displacement is expressed as:

$${μ}_{2 p} = \frac{( 1 + {μ}_{m} )}{{E}_{m}} \frac{{r}_{p}^{2} {r}_{2}^{2} {q}_{c}}{( {r}_{2}^{2} - {r}_{p}^{2} ) r} + \frac{( 1 - {μ}_{m} )}{{E}_{m}} \frac{{q}_{c} {r}_{p}^{2}}{{r}_{2}^{2} - {r}_{p}^{2}} r \qquad ( 5 )$$

where μₘ is a Poisson's ratio of the protective layer, and Eₘ is the elastic modulus of the protective layer. When the protective layer is also made of the high-performance concrete, μₘ=μ_{c}; and Eₘ=E_{c}.

According to a deformation coordination relationship, the radial displacement of the inner ring of the concrete is equal to the radial displacement of the outer ring at r=rₚ. An inner side of the inner ring is a critical cross-section for the calculation, and the circumferential stress is expressed as:

$${σ}_{φ1 p} = \frac{{r}_{1}^{2} + {r}_{p}^{2}}{{r}_{p}^{2} - {r}_{1}^{2}} {q}_{1} - \frac{2 {r}_{p}^{2}}{{r}_{p}^{2} - {r}_{1}^{2}} ( {q}_{2} + {q}_{c} ) \qquad ( 6 )$$

The core wall-thinning needs to take the impact of external loads including backfill soil, overburden soil, a pipe structure weight, water, and variable loads on wall-thinning into consideration, and the circumferential stress generated by the external loads is expressed as:

$${σ}_{p 2 t} = \frac{{M}_{p m s}}{{γ}_{c} {w}_{p}} \qquad ( 7 )$$

$${W}_{p} = \frac{B {T}^{2}}{6} \qquad ( 8 )$$

$$T = {t}_{c} + {t}_{y} + {d}_{s} + {t}_{m} \qquad ( 9 )$$

where Mₚₘₛ is a maximum bending moment of the cross-section caused by the external loads, Wₚ is an elastic resistance moment of a tensile edge of all sections of the pipe wall without conversion, and γ_{c} is a conversion coefficient of the elastic resistance moment of the tensile edge of an inner cross-section of the pipe wall, where a value is 0.9-1.1; B is a calculated cross-sectional width, and a value is 1000 mm; and T is a thickness of the pipe wall; and dₛ and tₘ are a diameter of a steel wire and a thickness of the protective layer.

A wall-thinning design calculation formula established according to the formulas (1-9) is expressed as:

$$\frac{{r}_{1}^{2} + {r}_{p}^{2}}{{r}_{p}^{2} - {r}_{1}^{2}} {q}_{1} - \frac{2 {r}_{p}^{2}}{{r}_{p}^{2} - {r}_{1}^{2}} ( {q}_{2} + {q}_{c} ) + \frac{{M}_{pms}}{{γ}_{c} {W}_{p}} = {α}_{ct} {f}_{tk} \qquad ( 10 )$$

where α_{ct} is a tensile stress restriction factor, value ranges of the high-performance concrete and ordinary concrete are 1.0-1.5 and 0.3-0.85, where the value ranges are selected according to different strengths of materials in the calculation, and fₜₖ is axial tensile strength of the concrete;
assuming that α_{ct}fₜₖ−Mₚₘₛ/(γ_{c}Wₚ)=F, a formula used for solving the core thickness rₚ is obtained by simplifying the equation:

$${a}_{0} {r}_{p}^{4} + {b}_{0} {r}_{p}^{3} + {c}_{0} {r}_{p}^{2} + {d}_{0} {r}_{p} + {e}_{0} \leq 0 \qquad ( 11 )$$

$${a}_{0} = {A}_{s} {f}_{sg} ( 1 - {μ}_{c} ) \qquad ( 12 )$$

$${b}_{0} = ( {r}_{2}^{2} - {r}_{1}^{2} ) F - ( {r}_{2}^{2} + {r}_{1}^{2} ) {q}_{1} \qquad ( 13 )$$

$${c}_{0} = {A}_{s} {f}_{sg} [ ( 1 + {μ}_{c} ) {r}_{2}^{2} + ( {μ}_{c} - 1 ) {r}_{1}^{2} ] \qquad ( 14 )$$

$${d}_{0} = ( {q}_{1} + F ) {r}_{1}^{4} + ( {q}_{1} - F ) {r}_{1}^{2} {r}_{2}^{2} \qquad ( 15 )$$

$${e}_{0} = - {A}_{s} {f}_{sg} {r}_{1}^{2} {r}_{2}^{2} ( 1 + {μ}_{c} ) \qquad ( 16 )$$

a, b, c, d, e∈R, a≠0, and double root discriminant is Δ=B²₀−4A₀C₀, and a formula for determining whether the pipe can achieve wall-thinning is expressed as:

$${A}_{0} = {D}_{0}^{2} - 3 {F}_{0} \qquad ( 17 )$$

$${B}_{0} = {D}_{0} {F}_{0} - 9 {E}_{0}^{2} \qquad ( 18 )$$

$${C}_{0} = {F}_{0}^{2} - 3 {D}_{0} {E}_{0}^{2} \qquad ( 19 )$$

$${D}_{0} = 3 {b}_{0}^{2} - 8 {a}_{0} {c}_{0} \qquad ( 20 )$$

$${E}_{0} = - {b}_{0}^{3} + 4 {a}_{0} {b}_{0} {c}_{0} - 8 {a}_{0}^{2} {d}_{0} \qquad ( 21 )$$

$${F}_{0} = 3 {b}_{0}^{4} + 16 {a}_{0}^{2} {c}_{0}^{2} - 16 {a}_{0} {b}_{0}^{2} {c}_{0} + 16 {a}_{0}^{2} {b}_{0} {d}_{0} - 64 {a}_{0}^{3} {e}_{0} \qquad ( 22 )$$

wall-thinning of the pipe can only be achieved if and only if Δ>0, and because a<0, b<0, c>0 are constant, Δ>0 is constant; there are two unequal real roots in the equation; and assuming that intermediate variables y₁, y₂, and y are:

$${y}_{1} = {A}_{0} {D}_{0} + 3 ( \frac{- {B}_{0} + \sqrt{{B}_{0}^{2} - 4 {A}_{0} {C}_{0}}}{2} ) , \\ {y}_{2} = {A}_{0} {D}_{0} + 3 ( \frac{- {B}_{0} - \sqrt{{B}_{0}^{2} - 4 {A}_{0} {C}_{0}}}{2} ) \qquad ( 23 )$$

$$y = {D}_{0}^{2} - {D}_{0} ( \sqrt[3]{{y}_{1}} + \sqrt[3]{{y}_{2}} ) + {( \sqrt[3]{{y}_{1}} + \sqrt[3]{{y}_{2}} )}^{2} - 3 {A}_{0} \qquad ( 24 )$$

and a real solution of the wall thickness r_{pd} after replacing with the high-performance concrete is expressed as:

$${r}_{pd , 1} = \frac{\begin{matrix}- {b}_{0} + [ a \cdot b \cdot s \cdot ( {E}_{0} ) / {E}_{0} ] \sqrt{\frac{{D}_{0} + \sqrt[3]{{y}_{1}} + \sqrt[3]{{y}_{2}}}{3}} + \\ \sqrt{\frac{2 {D}_{0} - ( \sqrt[3]{{y}_{1}} + \sqrt[3]{{y}_{2}} ) + 2 \sqrt{y}}{3}}\end{matrix}}{4 {a}_{0}} \qquad ( 25 )$$

$${r}_{pd , 2} = \frac{\begin{matrix}- {b}_{0} + [ a \cdot b \cdot s \cdot ( {E}_{0} ) / {E}_{0} ] \sqrt{\frac{{D}_{0} + \sqrt[3]{{y}_{1}} + \sqrt[3]{{y}_{2}}}{3}} - \\ \sqrt{\frac{2 {D}_{0} - ( \sqrt[3]{{y}_{1}} + \sqrt[3]{{y}_{2}} ) + 2 \sqrt{y}}{3}}\end{matrix}}{4 {a}_{0}}$$

A value of r_{pd} in the method needs to satisfy r₁<r_{pd}<r₁+t, and a maximum thickness of wall-thinning is dₚ=rₚ−r_{pd}.

Compared with that in the prior art, advantages and positive effects of the present invention are that:
The present invention provides a core wall-thinning design method for a prestressed high-performance concrete cylinder pipe, and the high-performance concrete replacing core concrete includes P.O 42.5 or P.O 52.5 portland cement, river sand, mineral powder, fly ash, silica fume, steel fibers, polypropylene fibers, a high-efficiency polycarboxylate superplasticizer, and superabsorbent resin. In this case, dense particle accumulation is satisfied and durability of the material is improved. The positive mixing effect can be exerted between steel fibers and polypropylene fibers, to improve tensile strength of the material, and increase circumferential stress that the pipe can withstand under internal pressure. The steel fibers can be used to delay cracking time of the pipe, and the superabsorbent resin can be used to improve the hydration of the high-performance concrete by releasing water, to inhibit shrinkage, and prevent shrinkage cracks in the pipe. According to the core wall-thinning design method, the circumferential stress on weak areas of cores (inner cores) of prestressed high-performance concrete cylinder pipes of different diameters under external loads and internal pressure can be accurately calculated. This fully leverages the superior mechanical properties of the high-performance concrete, and providing optimization potential for achieving wall-thinning design. In addition, the calculation method is also applicable to the PCCP, to determine whether the PCCP can achieve wall-thinning and calculate the wall-thinning thickness.

### BRIEF DESCRIPTION OF THE DRAWINGS

To more clearly illustrate the technical solution of embodiments of the present invention, the drawings that need to be used in the descriptions of the embodiments are briefly introduced one by one. It is clear that the drawings in the following descriptions are some embodiments of the present invention, and for a person of ordinary skill in the art, other drawings can also be obtained according to the drawings without creative effort.

FIG. 1 is a diagram of a structure of a prestressed high-performance concrete cylinder pipe; and

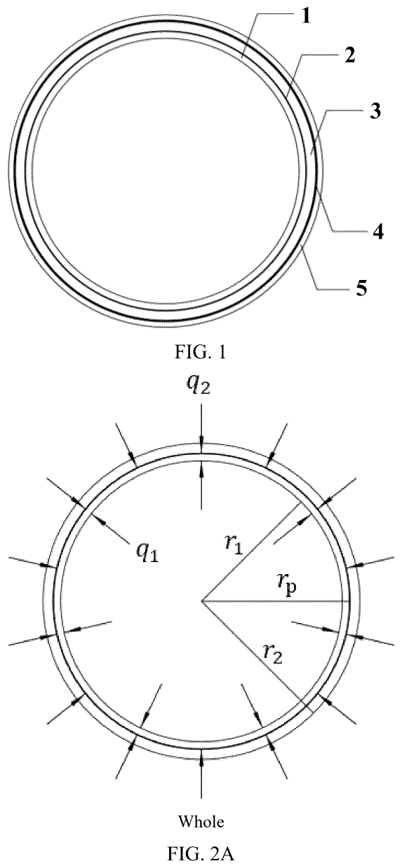

FIGS. 2A-2C are schematic diagrams of stress analysis for calculating a wall-thinning thickness of a prestressed high-performance concrete cylinder pipe according to Embodiment 1.

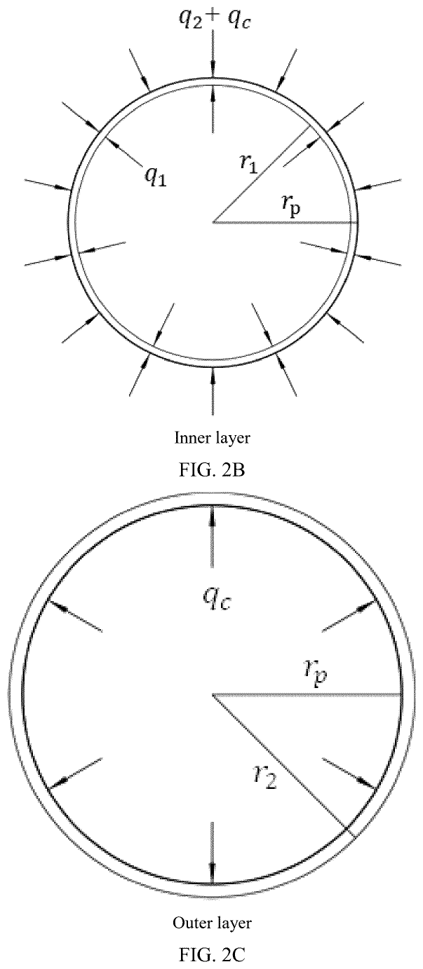

In the figures, 1: inner core; 2: cylinder; 3: outer core; 4: prestressed steel wire; and 5: protective layer.

### DETAILED DESCRIPTION OF THE EMBODIMENTS

To understand the objective, features, and advantages of the present invention more clearly, the present invention is further described below with reference to the accompanying drawings and embodiments. It should be noted that, without conflict, the embodiments of the present application and features in the embodiments may be combined with each other.

Many specific details are described in the following descriptions to facilitate a full understanding of the present invention. However, the present invention may also be implemented in other ways different from the descriptions herein. Therefore, the present invention is not limited to the specific embodiments of the following disclosed specification.

Embodiment 1: This embodiment is designed to resolve a problem of unclear mix proportions of high-performance concrete as a replacement material. In view of this, recommended dosage ranges of cementitious materials and aggregates per cubic meter of the high-performance concrete according to this embodiment is shown in Table 1, and recommended volume dosage ranges of other materials per cubic meter of the high-performance concrete is shown in Table 2. A method for the preparation of the high-performance concrete includes:
1. Adding all cementitious materials, sand and superabsorbent resin for dry mixing until uniform dispersion;
2. Dissolving the superplasticizer in water, and adding the superplasticizer dissolved in the water to mixture and evenly stirring the mixture; and
3. Evenly adding steel fibers and polypropylene fibers to the mixture and evenly stirring the mixture, where a compulsory mixer for stirring is suggested.

To ensure the mechanical properties of the material, the high-performance concrete preparation process needs to strictly follow the mixing sequence as required above, and even stirring needs to be ensured at all links.

TABLE 1
Recommended Dosage Ranges of Cementitious Materials and
Aggregates Per Cubic Meter of High-performance Concrete

| | | | | Ratio of | Ratio of |
|---|---|---|---|---|---|
| | | | | cementi- | water and |
| | | | | tious | cementi- |
| | Mineral | | Silica | materials | tious |
| Cement | powder | Fly ash | fume | and sand | materials |
| 40%-55% | 10%-20% | 10%-20% | 15%-25% | 0.8-1.2 | 0.18-0.22 |

TABLE 2
Recommended Volume Dosage Ranges of Other Materials
Per Cubic Meter of High-performance Concrete

| Steel | Polypropylene | Superabsorbent | |
|---|---|---|---|
| fiber | fiber | resin | Superplasticizer |
| 0.5%-1.5% | 0.5%-1.2% | 0.3%-0.6% | 1.5%-3% |

The replacement of the high-performance concrete with the core significantly improves the mechanical properties and durability of the material, and improves the stress distribution of the core under external loads. The interplay of a plurality of factors provides optimization potential for lightweight pipe design.

Embodiment 2: This embodiment provides an example of wall-thinning calculation of a DN2000 prestressed high-performance concrete cylinder pipe.

Based on the DN2000 PCCP in the project, a core is replaced with high-performance concrete and the wall-thinning design is achieved. The basic geometric dimensioning of the pipe before the replacement is shown in Table 3.

TABLE 3
Geometric Dimensioning of DN2000 Prestressed
High-performance Concrete Cylinder Pipe

| Pipe | | Steel | | Protective | Steel |
|---|---|---|---|---|---|
| inner | Cylinder | wire | Core | layer | wire |
| diameter | thickness | diameter | thickness | thickness | area |
| 2000 mm | 1.5 mm | 6 mm | 125 mm | 50 mm | 1557 mm² |

In addition, a covering depth of the pipe is 3 m, working internal pressure is 0.8 MPa, and designed internal water pressure is 1.12 Mpa. Sizes of each load under external loads is shown in Table 4.

TABLE 4
External Loads Action Values

| Vertical soil | Lateral soil | | | |
|---|---|---|---|---|
| pressure | pressure | Pipe weight | Fluid weight | Variable loads |
| 156.07 kN/m | 24.91 kN/m² | 24.59 kN/m | 31.42 kN/m | 10 kN/m² |

The compressive strength of the high-performance concrete prepared by the foregoing mix ratio is 90 MPa, the tensile strength is 6.4 MPa, and a core wall-thinning thickness is about 22 mm through calculation. The thickness of the core after wall-thinning is 103 mm.

The foregoing descriptions are only better embodiments of the present invention and are not construed as any limitation on the present invention in other forms. Any person skilled in the art may change or modify the disclosed technical solutions into equivalent embodiments of equivalent changes for applications in other fields. Any simple modification, equivalent changes, and modifications made to the foregoing embodiments according to the technical essence of the present invention shall still fall within the protection scope of the technical solutions of the present invention without departing from the technical solutions of the present invention.

What is claimed is:

1. A core wall-thinning design method for a prestressed high-performance concrete cylinder pipe, comprising the following steps: replacing a core concrete of a prestressed concrete cylinder pipe (PCCP) with a high-performance concrete, and using the core wall-thinning design method to achieve wall-thinning of the PCCP.

2. The core wall-thinning design method according to claim 1, wherein in the step of replacing the core concrete of the PCCP with the high-performance concrete, the high-performance concrete comprises P.O 42.5 or P.O 52.5 portland cement, river sand, mineral powder, fly ash, silica fume, steel fibers, polypropylene fibers, a high-efficiency polycarboxylate superplasticizer, and superabsorbent resin.

3. The core wall-thinning design method according to claim 1, wherein in the step of replacing the core concrete of the PCCP with the high-performance concrete, a method for mixing the high-performance concrete comprises: adding cementitious materials, sand and the superabsorbent resin for dry mixing until a uniform dispersion to obtain a first mixture;
dissolving the high-efficiency polycarboxylate superplasticizer in water to obtain a dissolved superplasticizer, and adding the dissolved superplasticizer to the first mixture to obtain a second mixture and evenly stirring the second mixture; and evenly adding the steel fibers and the polypropylene fibers to the second mixture to obtain a third mixture and evenly stirring the third mixture.

4. The core wall-thinning design method according to claim 1, wherein in the step of replacing the core concrete of the PCCP with the high-performance concrete, after the high-performance concrete is made, a core mold needs to be first cleaned up, a separator is evenly sprayed, a position of the core mold is fixed, and a cylinder is put into the core mold; the high-performance concrete is cast, a cast surface of an inner concrete is higher than a cast surface of an outer concrete, and a vibrator is turned on when feeding, until a concrete surface is free of bubbles and stops vibrating; after a core is formed, steam curing is performed, and a heating rate of the steam curing is configured to be less than or equal to 25/h; and a cubic test block is reserved in an identical batch during casting, and when a compressive strength of the cubic test block is greater than or equal to 36 MPa, the PCCP is allowed to be demolded and the core concrete is formed.

5. The core wall-thinning design method according to claim 1, wherein in the step of using the wall-thinning design method to achieve the wall-thinning of the PCCP, the core wall-thinning design method comprises the following steps: establishing an axisymmetric double-layer ring plane strain model, to separately analyze radial displacements and circumferential stresses of an outer ring and an inner ring of the PCCP, and deriving a calculation formula of a wall-thinning design of the PCCP.

6. The core wall-thinning design method according to claim 5, wherein the step of establishing the axisymmetric double-layer ring plane strain model comprises: simplifying the PCCP to the axisymmetric double-layer ring plane strain model, comprising converting the inner ring being defined as the core concrete plus a thickness of a cylinder into a cylinder concrete, and converting the outer ring being defined as a protective layer into the core concrete according to a cylinder stiffness contribution, wherein a conversion method is:
$${t}_{y}^{′} = \frac{{E}_{y}}{{E}_{c}} {t}_{y} \qquad 1 )$$
$$t = {t}_{y}^{′} + {t}_{c} \qquad 2 )$$
$$t = {r}_{p} + {r}_{1} \qquad 3 )$$
wherein t_{y} is the thickness of the cylinder, E_{y} and E_{c} are elastic modulus of the cylinder and the high-performance concrete, t′_{y} is a thickness of the cylinder concrete, t_{c} and t are a concrete core and an effective thickness after a conversion, r₁ is an inner diameter of the inner ring, and rₚ is an outer diameter of the inner ring; and the radial displacement of an inner water pressure on the inner ring, a preload pressure on the inner ring, and a contact stress of the outer ring on the inner ring is expressed as:
$${μ}_{1 p} = \frac{( 1 + {μ}_{c} )}{{E}_{c}} \frac{{r}_{1}^{2} {r}_{p}^{2} ( {q}_{1} - {q}_{2} - {q}_{c} )}{( {r}_{p}^{2} - {r}_{1}^{2} ) r} + \frac{( 1 - {μ}_{c} )}{{E}_{c}} \frac{{q}_{1} {r}_{1}^{2} - ( {q}_{2} + {q}_{c} ) {r}_{p}^{2}}{{r}_{p}^{2} - {r}_{1}^{2}} r \qquad 4 )$$
wherein q₁ is the inner water pressure on the inner ring, q₂ is the preload pressure on the inner ring, q_{c} is the contact stress of the outer ring on the inner ring, μ_{c} is a Poisson's ratio of the high-performance concrete, E_{c} is the elastic modulus of the high-performance concrete, and μ₁ₚ is the radial displacement of the inner ring under a load; and the outer ring is only subjected to an interlayer contact stress of the inner ring on the outer ring, and the radial displacement of the outer ring under the load is expressed as:
$${μ}_{2 p} = \frac{( 1 + {μ}_{m} )}{{E}_{m}} \frac{{r}_{p}^{2} {r}_{2}^{2} {q}_{c}}{( {r}_{2}^{2} - {r}_{p}^{2} ) r} + \frac{( 1 - {μ}_{m} )}{{E}_{m}} \frac{{q}_{c} {r}_{p}^{2}}{{r}_{2}^{2} - {r}_{p}^{2}} r \qquad 5 )$$
wherein μₘ is a Poisson's ratio of the protective layer, Eₘ is an elastic modulus of the protective layer, and μ₂ₚ is the radial displacement of the outer ring under the load; when the protective layer is further made of the high-performance concrete, μₘ=μ_{c}; and Eₘ=E_{c}; an inner side of the inner ring is a critical calculated cross-section, and the circumferential stress of the inner ring is expressed as:
$${σ}_{φ1 p} = \frac{{r}_{1}^{2} + {r}_{p}^{2}}{{r}_{p}^{2} - {r}_{1}^{2}} {q}_{1} - \frac{2 {r}_{p}^{2}}{{r}_{p}^{2} - {r}_{1}^{2}} ( {q}_{2} + {q}_{c} ) . \qquad 6 )$$

7. The core wall-thinning design method according to claim 5, wherein the core wall-thinning design method needs to take an impact of external loads comprising backfill soil, overburden soil, a pipe structure weight, water, and variable loads on the wall-thinning into consideration, and a circumferential stress generated by the external loads is expressed as:
$${σ}_{p 2 t} = \frac{{M}_{pms}}{{γ}_{c} {w}_{p}} \qquad 7 )$$
$${W}_{p} = \frac{{BT}^{2}}{6} \qquad 8 )$$
$$T = {t}_{c} + {t}_{y} + {d}_{s} + {t}_{m} \qquad 9 )$$
wherein Mₚₘₛ is a maximum bending moment of a cross-section caused by the external loads, Wₚ is an elastic resistance moment of a tensile edge of all sections of a pipe wall without a conversion, and ye is a conversion coefficient of an elastic resistance moment of a tensile edge of an inner cross-section of the pipe wall, wherein a value of γ_{c} is 0.9-1.1; B is a calculated cross-sectional width, and a value of B is 1000 mm; Tis a thickness of the pipe wall; and dₛ and tₘ are a diameter of a steel wire and a thickness of a protective layer.

8. The core wall-thinning design method according to claim 5, wherein a wall-thinning design calculation formula established according to the formulas 1-9 in the core wall-thinning design method is expressed as:
$$\frac{{r}_{1}^{2} + {r}_{p}^{2}}{{r}_{p}^{2} - {r}_{1}^{2}} {q}_{1} - \frac{2 {r}_{p}^{2}}{{r}_{p}^{2} - {r}_{1}^{2}} ( {q}_{2} + {q}_{c} ) + \frac{{M}_{pms}}{{γ}_{c} {W}_{p}} = {α}_{ct} {f}_{tk} \qquad 10 )$$
wherein α_{ct} is a tensile stress restriction factor, value ranges of the high-performance concrete and an ordinary concrete are 1.0-1.5 and 0.3-0.85, wherein the value ranges are selected according to different strengths of materials in a calculation, and fₜₖ is an axial tensile strength of the high-performance concrete or the ordinary concrete;
assuming that α_{ct}fₜₖ−Mₚₘₛ/(γ_{c}Wₚ)=F, a formula configured for solving a core thickness rₚ is obtained by simplifying an equation:
$${a}_{0} {r}_{p}^{4} + {b}_{0} {r}_{p}^{3} + {c}_{0} {r}_{p}^{2} + {d}_{0} {r}_{p} + {e}_{0} \leq 0 \qquad 11 )$$
$${a}_{0} = {A}_{s} {f}_{sg} ( 1 - {μ}_{c} ) \qquad 12 )$$
$${b}_{0} = ( {r}_{2}^{2} - {r}_{1}^{2} ) F - ( {r}_{2}^{2} + {r}_{1}^{2} ) {q}_{1} \qquad 13 )$$
$${c}_{0} = {A}_{s} {f}_{sg} [ ( 1 + {μ}_{c} ) {r}_{2}^{2} + ( {μ}_{c} - 1 ) {r}_{1}^{2} ] \qquad 14 )$$
$${d}_{0} = ( {q}_{1} + F ) {r}_{1}^{4} + ( {q}_{1} - F ) {r}_{1}^{2} {r}_{2}^{2} \qquad 15 )$$
$${e}_{0} = - {A}_{s} {f}_{sg} {r}_{1}^{2} {r}_{2}^{2} ( 1 + {μ}_{c} ) \qquad 16 )$$
a, b, c, d, e∈R, a≠0, and a double root discriminant is Δ=B²₀−4A₀C₀, and a formula for determining whether the PCCP is allowed to achieve the wall-thinning is expressed as:
$${A}_{0} = {D}_{0}^{2} - 3 {F}_{0} \qquad 17 )$$
$${B}_{0} = {D}_{0} {F}_{0} - 9 {E}_{0}^{2} \qquad 18 )$$
$${C}_{0} = {F}_{0}^{2} - 3 {D}_{0} {E}_{0}^{2} \qquad 19 )$$
$${D}_{0} = 3 {b}_{0}^{2} - 8 {a}_{0} {c}_{0} \qquad 20 )$$
$${E}_{0} = - {b}_{0}^{3} + 4 {a}_{0} {b}_{0} {c}_{0} - 8 {a}_{0}^{2} {d}_{0} \qquad 21 )$$
$${F}_{0} = 3 {b}_{0}^{4} + 16 {a}_{0}^{2} {c}_{0}^{2} - 16 {a}_{0} {b}_{0}^{2} {c}_{0} + 16 {a}_{0}^{2} {b}_{0} {d}_{0} - 64 {a}_{0}^{3} {e}_{0} \qquad 22 )$$
wherein the wall-thinning of the PCCP is allowed to only be achieved when and only when Δ>0, and because a<0, b<0, c>0 are constant, Δ>0 is constant; there are two unequal real roots in the equation; and assuming that intermediate variables y₁, y₂, and y are:
$${y}_{1} = {A}_{0} {D}_{0} + 3 ( \frac{- {B}_{0} + \sqrt{{B}_{0}^{2} - 4 {A}_{0} {C}_{0}}}{2} ) , \\ {y}_{2} = {A}_{0} {D}_{0} + 3 ( \frac{- {B}_{0} - \sqrt{{B}_{0}^{2} - 4 {A}_{0} {C}_{0}}}{2} ) \qquad 23 )$$
$$y = {D}_{0}^{2} - {D}_{0} ( \sqrt[3]{{y}_{1}} + \sqrt[3]{{y}_{2}} ) + {( \sqrt[3]{{y}_{1}} + \sqrt[3]{{y}_{2}} )}^{2} - 3 {A}_{0} \qquad 24 )$$
and a real solution of a wall thickness r_{pd} after replacing with the high-performance concrete is expressed as:
$${r}_{pd , 1} = \frac{\begin{matrix}- {b}_{0} + [ a \cdot b \cdot s \cdot ( {E}_{0} ) / {E}_{0} ] \sqrt{\frac{{D}_{0} + \sqrt[3]{{y}_{1}} + \sqrt[3]{{y}_{2}}}{3}} + \\ \sqrt{\frac{2 {D}_{0} - ( \sqrt[3]{{y}_{1}} + \sqrt[3]{{y}_{2}} ) + 2 \sqrt{y}}{3}}\end{matrix}}{4 {a}_{0}} \qquad 25 )$$
$${r}_{pd , 2} = \frac{\begin{matrix}- {b}_{0} + [ a \cdot b \cdot s \cdot ( {E}_{0} ) / {E}_{0} ] \sqrt{\frac{{D}_{0} + \sqrt[3]{{y}_{1}} + \sqrt[3]{{y}_{2}}}{3}} - \\ \sqrt{\frac{2 {D}_{0} - ( \sqrt[3]{{y}_{1}} + \sqrt[3]{{y}_{2}} ) + 2 \sqrt{y}}{3}}\end{matrix}}{4 {a}_{0}} .$$

9. The core wall-thinning design method according to claim 8, wherein a value of r_{pd} in the core wall-thinning design method needs to satisfy r₁<r_{pd}<r₁+t, and a maximum thickness of the wall-thinning is dₚ=rₚ−r_{pd}.
